(19) United States
(12) Patent Application Publication
(10) Pub. No.: US 2013/0214136 A1
(43) Pub. Date: Aug. 22, 2013

(54) LIGHT CURTAIN

(71) Applicant: Leuze electronic GmbH + Co. KG, (US)

(72) Inventors: Arnold SCHOENLEITNER, Purkersdorf (AT); Robert Schedlberger, Bad Zell (AT)

(73) Assignee: Leuze electronic GmbH + Co. KG, Owen/Teck (DE)

(21) Appl. No.: 13/773,169

(22) Filed: Feb. 21, 2013

(30) Foreign Application Priority Data
Feb. 21, 2012 (DE) 102012101369.1

(51) Int. Cl. G01V 8/20

(52) U.S. Cl. CPC G01V 8/20
USPC 250/222.1

(57) ABSTRACT

A light curtain to detect objects within a monitored region comprises an arrangement of transmitters that emit light rays, an arrangement of receivers for receiving the light rays, and an evaluation unit in which an object detection signal is generated in dependence on signals present at an output of the receivers. The transmitters and the receivers are activated via output lines of an arrangement of computing units, wherein the computing units make it possible to freely select points in time for activating individual transmitters and receivers.

### CROSS-REFERENCE TO RELATED APPLICATION

This application claims the priority of German Patent Application DE 10 2012 101369.1, filed on Feb. 21, 2012, the subject matter of which is incorporated herein by reference.

### BACKGROUND

Light curtains, in general, function to detect objects in a monitored region and comprise a transmitting unit with an arrangement of transmitters that emit light rays and a receiving unit with an arrangement of receivers for receiving the light rays. The transmitting unit and the receiving unit are arranged at opposite edges of the monitored region, such that if the monitored region is clear, the light rays from a transmitter impinge on an opposite-arranged, associated receiver, wherein this transmitter/receiver pair forms a beam axis for the light curtain. The individual beam axes of the light curtain are activated one after another during a cycle. For this, a control unit is integrated into the transmitting unit which actuates a shift register in such a way that the individual transmitters are activated one after another. An evaluation unit is integrated into the receiving unit which actuates a different shift register, such that the individual receivers are also activated one after another. The activation of the transmitters and the receivers is synchronized either optically or electronically. As a result of this synchronization, the individual transmitter/receiver pairs of the light curtain are activated one after another during the cycle.

In order to generate an object detection signal in the form of a binary switching signal, an evaluation of the receiving signal amplitude is realized in the evaluation unit with the aid of one or several threshold values. A check is carried out within one cycle, during which all transmitter/receiver pairs are successively activated, to determine whether the light rays of at least one beam axis are interrupted. If that is the case, the evaluation unit emits an object message for the switching signal state. If no beam axis is interrupted, the switching signal state indicates a clear monitored region.

These types of light curtains have the disadvantage of a relatively slow repetition rate for generating the switching signal since a complete, fixedly predetermined passage of all beam axes of the light curtain must take place for each new generating of the switching signal. To be sure, the individual activation of all transmitter/receiver pairs within one cycle can in principle be changed through blanking out specified beam axes, meaning these beam axes are not used for evaluating and generating the object detection signal. This variation, however, does not result in increasing the repetition rate for generating the switching signal.

### SUMMARY

It is an object of the present invention to provide a light curtain which has a higher functionality with lower structural expenditure.

The above and other objects are solved according to embodiments of the present invention such as, for example, by the provision of a light curtain for detecting objects within a monitored region, comprising a light curtain for detecting objects within a monitored region, comprising: an arrangement of transmitters that emit light rays; an arrangement of receivers for receiving the light rays; an evaluation unit in which an object detection signal is generated in dependence on signals present at an output of the receivers; and an arrangement of computing units having output lines coupled to the transmitters and the receivers, wherein the transmitters and receivers are activated via the output lines of the arrangement of computing units, and wherein the computing units are configured to freely select points in time for activating individual transmitters and receivers.

The light curtain according to an embodiment of the present invention is used to detect objects within a monitored region and comprises a transmitter arrangement for emitting light rays, a receiver arrangement for receiving light rays and an evaluation unit in which an object detection signal is generated in dependence on the signals present at the receiver outputs. The transmitters and the receivers are activated with the aid of output lines for an array of computer units, wherein the points in time for activating the individual transmitters and receivers can be selected freely via these computer units.

With the light curtain according an embodiment of the present invention, the activation of the transmitters and receivers in general can be specified anew for each individual measuring cycle within which an object detection signal is generated.

According to an embodiment of the present invention, within each measuring cycle for the light curtain, the number and also the sequence of the activated transmitters and receivers can be flexibly varied, corresponding to the respective application requirements.

In general, it is also possible with the light curtain according an embodiment of the present invention to activate several transmitters and receivers simultaneously, thereby making it possible to considerably increase the repetition rate for generating the object detection signal.

In particular, for detecting specific object structures within a segment of the monitored region, only a small number of transmitters and a small number of receivers are activated during each measuring cycle. As a result, the measuring cycle time can be kept low and the repetition rate for generating the object detection signal can be increased considerably.

According to an embodiment of the present invention, the activated transmitters and receivers can also form a temporally changing region which moves along with an object when it passes through the monitored region. This represents an especially precise adaptation of activated transmitter/receiver regions to the respective object detection.

According to an embodiment of the present invention, sections of the monitored region which are to be blanked out can be specified simply by not activating the transmitters and receivers covering these regions.

According to an embodiment of the present invention, the sequence for activating the transmitters and receivers can be adapted, for example, when tracking objects which change their movement direction.

According to an embodiment of the present invention where the light cones of the light rays impinge on several receivers, diagonal or cross beam paths can be generated for the beam axes of the light curtain through selective activation of a partial number of these receivers, so that more complex object structures can also be detected if necessary.

According to an embodiment of the present invention with multiple light curtains having a specified sequence for activating the transmitters and receivers, a mutual optical influencing of the light curtains can be avoided. In that case, only those transmitter and receiver groups of different light curtains are activated simultaneously for which there is no danger of a mutual influencing because of their geometric arrangement. Owing to the fact that the light curtain operation is thus optimized and the transmitters and receivers of the different light curtains may also be activated simultaneously without the danger of mutually influencing each other, high repetition rates for generating the object detection signals can be achieved for these light curtains during an uninterrupted operation, meaning that a fast object detection is possible.

According to an embodiment of the present invention, the activation of the transmitters and the receivers is controlled via a central control unit, wherein the central control unit may also function as an evaluation unit in which the object detection signal is generated.

According to an embodiment of the present invention, the light curtain may further comprise a transmitting unit with a number of transmitters to which an arrangement of microcontrollers is assigned, wherein the transmitters are connected to port lines of the microcontrollers. The light curtain may further comprise a receiving unit with a number of receivers to which an arrangement of microcontrollers is assigned, wherein the receivers are connected to port lines of the microcontrollers. The transmitting unit and the receiving unit may be connected via a digital bus to the central control unit.

A transmitter/receiver pair may be formed with respectively one transmitter of the transmitting unit and one opposite arranged receiver, belonging to the receiving unit, on which the light rays arriving from the associated transmitter impinge, provided the monitored region is clear. In dependence on the actual requirements, individual transmitter/receiver pairs may be activated during each measuring cycle via the central control unit.

The activation of the individual transmitter/receiver pairs may occur via the central control unit which activates the port line for the microcontrollers of the respectively associated transmitter/receiver pairs. For this, the central control unit transmits suitable signals via the digital bus.

The digital bus transmits telegrams containing special byte values which function to actuate the transmitters and receivers.

As a result, the already existing communication structures for the digital bus may also be utilized for activating the individual transmitters and receivers, meaning no additional structural measures are required.

According to an embodiment of the present invention, the port states for the port lines to be activated can be stored in the individual microcontrollers during a configuration process for the individual measuring cycles, wherein these port states are then generated via the central control unit, meaning the port lines are specified which must be activated during one measuring cycle.

However, this requires a relatively high expenditure for the data communication and furthermore requires a lot of storage space in the individual microcontrollers.

According to an embodiment of the present invention, run lists are stored in the microcontrollers for the transmitting unit and the receiving unit, wherein these lists contain the activation times for the transmitters and the receivers within one measuring cycle. In order to activate specified transmitters and receivers, trigger signals may be transmitted by the central unit to the associated microcontrollers which contain references to the run lists stored therein. The references may be in the form of counting pulses which follow a starting pulse. With the aid of the references contained in the trigger signal, the port line for the transmitter or receiver to be activated is computed from the respective run list. The run lists may be read during a configuration process into the microcontrollers for the transmitting unit and the receiving unit.

The activation of the individual transmitters and receivers may be simplified considerably with this method. As a result of the trigger signal received from the central control unit, each microcontroller can compute easily which port lines must be activated at the specified times by referring to this run list. In particular, it is possible with the aid of a suitable setup of the run lists to combine time intervals during which specific port lines should not be activated by the microcontrollers, thereby considerably shortening the run list.

### BRIEF DESCRIPTION OF THE DRAWINGS

These and other features and advantages of the invention will be further understood from the following detailed description of various embodiments with reference to the accompanying drawings in which:

FIG. 1 shows a schematic representation of an exemplary embodiment of the light curtain according to the invention;

FIG. 2a shows a part of the temporal sequence for the detection of an object moving through the region monitored by the light curtain ;

FIG. 2b shows a part of the temporal sequence for the detection of an object moving through the region monitored by the light curtain;

FIG. 2c shows a part of the temporal sequence for the detection of an object moving through the region monitored by the light curtain.

### DETAILED DESCRIPTION

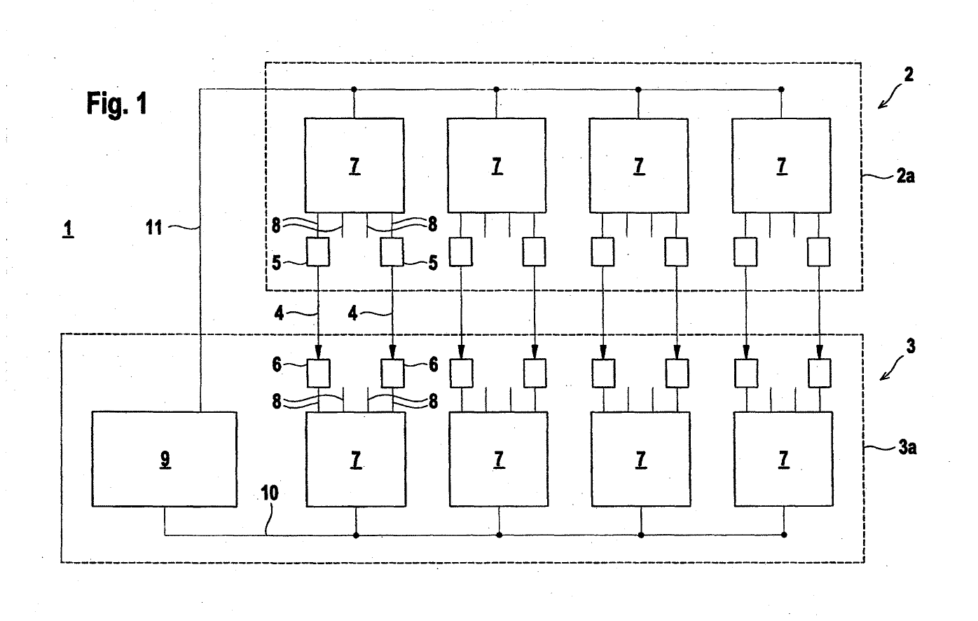

FIG. 1 shows an embodiment of a light curtain 1. The light curtain 1 comprises a transmitting unit 2 with a first casing 2a and a receiving unit 3 with a second casing 3a. The transmitting unit 2 and the receiving unit 3 are arranged on opposite edges of a monitored region, within which objects can be detected by the light curtain 1.

A linear arrangement of transmitters 5 for emitting light rays 4 may be positioned inside the casing 2a for the transmitting unit 2. A number of receivers 6 for receiving the light rays 4 may be positioned inside the casing 3a of the receiving unit 3, wherein these receivers may also form a linear arrangement and correspond to the number of transmitters 5. The transmitters 5 may be light-emitting diodes, laser diodes or the like. The receivers 6 may be photoelectric diodes. Not shown herein may be transmitting optics arranged downstream of the transmitters 5 for forming a beam with the light rays 4. Receiving optics, also not shown herein, may be arranged upstream of the receivers 6 for focusing the light rays 4 into a beam.

As can be seen in FIG. 1, arranged opposite each transmitter 5 may be a thereto assigned receiver 6, such that with a clear monitored region the light rays 4 of this transmitter 5 can impinge on the associated receiver 6. The transmitter 5 and the receiver 6 may thus form a transmitter/receiver pair and a so-called beam axis for the light curtain 1. Eight of these beam axes are provided in the present embodiment, wherein the number of beam axes for the light curtain 1 can vary. Depending on the requirements, the light rays 4 emitted by a transmitter 5 may also impinge on several receivers 6.

The transmitting unit 2 may comprise an arrangement of computing units which may comprise microcontrollers 7. The individual transmitters 5 may be connected to specific port lines 8 of the microcontrollers 7, wherein each microcontroller 7 may comprise a plurality of port lines 8. In the present embodiment, two transmitters 5 are connected via a separate port line 8 to each microcontroller 7.

The receiving unit 3 may also comprise an arrangement of microcontrollers 7. The individual receivers 6 may be connected to specific port lines 8 of the microcontrollers 7, wherein two receivers 6 may be respectively connected via a separate port line 8 to each microcontroller 7.

The receiving unit 3 may further contain a central control unit 9 which may be an additional microcontroller. The central control unit 9 may be connected via bus lines 10 of a digital bus to the microcontrollers 7 of the receiving unit 3. The central control unit 9 may be further connected via bus lines 11 of the digital bus to the microcontrollers 7 of the transmitting unit 2. The bus lines 10, 11 may be components of a single bus.

The central control unit 9 may function to actuate and activate the individual transmitters 5 and the receivers 6. The central control unit 9 may also function as an evaluation unit in which an object detection signal is generated in dependence on the signals that are received. A threshold value weighting of the signals received at the receiver 6, such as comparing the signals received at the receiver 6 to a threshold value, may occur in the evaluation unit, thus making it possible to determine whether the light rays 4 of the respective beam axes are interrupted by an object intervention.

The transmitters 5 and the receivers 6 of the light curtain 1 may be respectively activated via the central control unit 9 during the individual, successively following measuring cycles, wherein the central control unit 9 may freely select the position for and the number of the individual transmitters 5 and the receivers 6. Within each measuring cycle, a separate object detection signal may be generated for the activated transmitters 5 and the receivers 6.

The number of transmitters 5 and receivers 6 to be activated in the individual measuring cycles may be determined during a configuration process. For this, run lists are transmitted via the central control unit 9 to the individual microcontrollers 7 of the transmitting and receiving units 2, 3 and may be stored therein. These run lists contain indices of the individual transmitters 5 and the receivers 6 to be activated, as well as the activation times during the measuring cycle, thereby defining the sequence for activating the transmitters 5 and the receivers 6 within the respective measuring cycle.

During the light curtain operation following the configuration process, the central control unit 9 may transmit trigger signals to the microcontrollers 7. These trigger signals may be transmitted in the form of bit signals via the digital bus. The microcontrollers 7 of the transmitting and receiving unit 2, 3 may be connected parallel to the digital bus for this, so that all microcontrollers 7 receive the signals from the central control unit 9.

The trigger signals may contain references to specific indices in the run lists which are stored in the microcontrollers 7. According to the present embodiment, the references take the form of counting pulses that follow a starting pulse. If a microcontroller 7 receives such a trigger signal, the respective transmitter 5 to be activated and/or the respective receiver 6 to be activated may be computed therein with the aid of the referenced index, and the activation time may be determined from the run list. In this way, the transmitters 5 and the receivers 6 are activated during a single measuring cycle.

According to an embodiment of the present invention, the transmitters 5 and the receivers 6 of a transmitter/receiver pair are always activated simultaneously, so that the beam axis can function to detect an object.

According to an embodiment of the present invention, all transmitter/receiver pairs within one measuring cycle, meaning all beam axes of the light curtain 1, are activated successively within one measuring cycle. A check is carried out during each measuring cycle to determine whether an object intervention exists for at least one beam axis, meaning an interruption of the light rays 4 of this beam axis. If that is the case, an object message is issued in the form of an object detection signal. If no interruption of the light rays 4 exists for any of the beam axes, then the object detection signal indicates a clear monitored region.

The activation of successive transmitter/receiver pairs may occur with a specific clocking rate, meaning the time interval between the activation of two successively following transmitter/receiver pairs is constant. Since all eight transmitter/receiver pairs maybe activated within one measuring cycle, the duration of the measuring cycle is eight times the clocking rate.

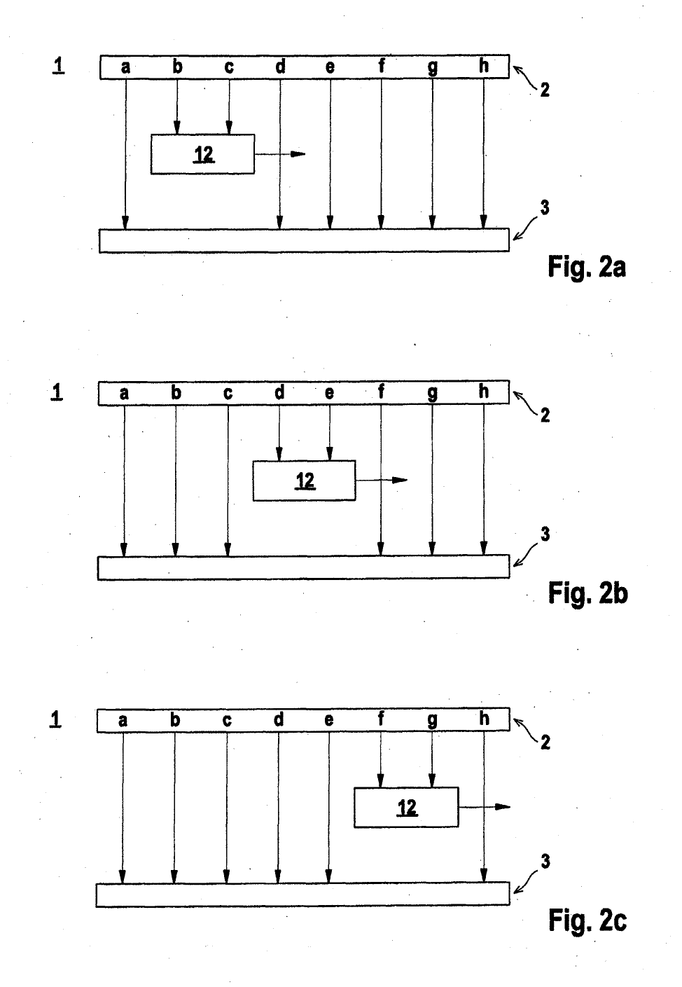

FIGS. 2a- 2c show an embodiment of the light curtain 1 according to FIG. 1. According to this embodiment of the present invention, an object is tracked with the light curtain 1 in such a way that an object 12 is moved with a speed v through the monitored region and, in the process, is continuously detected with the light curtain 1. FIGS. 2a- 2c show the object 12 at different times and in different positions within the monitored region. The individual beam axes of the light curtain 1 in this case are numbered consecutively with the letters a to h. As can be seen in FIGS. 2a to 2c, the object 12 dimensions are such that a maximum of two beam axes are interrupted by this object. Not all beam axes, meaning their transmitter/receiver pairs, are therefore activated by the central control unit 9 in each measuring cycle. Rather, only four beam axes are activated during each measuring cycle while the remaining four beam axes are deactivated.

Once the object 12 has entered the monitored region, only the first four beam axes a to d are activated (FIG. 2a). The object is detected with the beams b, c while the additionally activated beam axes a, d are not interrupted. The position and the dimensions of the object 12 can be controlled by evaluating the signals received at the receiver 6 for the beam axes a to d. The beam axes may be activated in an ascending order a, b, c, d within one measuring cycle.

The window for the four activated beam axes travels along with the object 12 through the region that is monitored. Accordingly, as shown in FIG. 2b, only the beam axes c, d, e and f are activated if the object 12 is located in the center of the monitored region. FIG. 2c also shows that only the beam axes e, f, g, h are activated if the object 12 has moved in the direction of the exit for the monitored region.

Since only four beam axes are successively activated during each measuring cycle, and not all eight beam axes as shown in FIG. 1, the cycle time of a measuring cycle is cut in half, meaning the object detection signal is generated with twice the repetition rate.

It will be understood that the above description of the present invention is susceptible to various modifications, changes and adaptations, and the same are intended to be comprehended within the meaning and range of equivalents of the appended claims.

We claim:

1. A light curtain for detecting objects within a monitored region, comprising:
an arrangement of transmitters that emit light rays;
an arrangement of receivers for receiving the light rays;
an evaluation unit in which an object detection signal is generated in dependence on signals present at an output of the receivers; and
an arrangement of computing units having output lines coupled to the transmitters and the receivers,
wherein the transmitters and receivers are activated via the output lines of the arrangement of computing units, and
wherein the computing units are configured to freely select points in time for activating individual transmitters and receivers.

2. The light curtain of claim 1, wherein the object detection signal is always generated at an end of a measuring cycle, wherein for each measuring cycle a number of activated transmitters and receivers and their activation times are specified anew.

3. The light curtain of claim 1, further comprising a central control unit connected to activate the transmitters and the receivers.

4. The light curtain of claim 3, wherein the central control unit includes the evaluation unit in which the object detection signal is generated.

5. The light curtain of claim 1, wherein the arrangement of computing units comprises a first arrangement of microcontrollers, and further comprising a transmitting unit including the first arrangement of microcontrollers and the transmitters to which the first arrangement of microcontrollers is assigned, wherein the transmitters are connected to port lines of the microcontrollers in the first arrangement of microcontrollers.

6. The light curtain of claim 5, wherein the computing units comprise a second arrangement of microcontrollers, and further comprising a receiving unit including the second arrangement of microcontrollers and the receivers to which the second arrangement of microcontrollers is assigned, wherein the receivers are connected to port lines of the microcontrollers in the second arrangement of microcontrollers.

7. The light curtain of claim 6, wherein the microcontrollers of the transmitting unit and the receiving unit are connected via a digital bus to the central control unit.

8. The light curtain of claim 7, wherein telegrams are sent via the digital bus, wherein special byte values of the telegrams function to activate the transmitters and the receivers.

9. The light curtain of claim 7, wherein run lists are stored in the microcontrollers of the transmitting unit and receiving unit which contain the activation times for the transmitters and the receivers during one measuring cycle, and trigger signals are transmitted from the central control unit to the microcontrollers for activating specific transmitters or receivers, wherein the trigger signals contain references to the run lists stored therein.

10. The light curtain of claim 9, wherein the port line for the transmitter or the receiver to be activated is computed in an associated microcontroller with the aid of the references in the trigger signal to the respective run list.

11. The light curtain of claim 9, wherein the run lists are read into the microcontrollers for the transmitting unit and the receiving unit during a configuration process.

12. A method of detecting objects within a monitored region with a light curtain, the light curtain having an arrangement of transmitters, and an arrangement of receivers, the method comprising:
emitting light rays from the arrangement of transmitters,
receiving the light rays with the arrangement of receivers,
generating an object detection signal in dependence on signals present at an output of the receivers, and
freely selecting points in time for activating individual receivers and transmitters.

13. The method of claim 12, further comprising always generating the object detection signal at an end of a measuring cycle, and newly specifying a number of activated transmitters and receivers and their activation times for each measuring cycle.

14. The method of claim 12, wherein the activating individual transmitters and receivers is done by a central control unit.

15. The method of claim 14, wherein the generating an object detection signal is done by the central control unit.

16. The method of claim 12, further comprising connecting a number of transmitters to a first arrangement of microcontrollers.

17. The method of claim 16, further comprising connecting a number of receivers to a second arrangement of microcontrollers.

18. The method of claim 17, further comprising connecting the first arrangement of microcontrollers and the second arrangement of microcontrollers via a respective digital bus to the central control unit.

19. The method of claim 17, further comprising
storing run lists in the first and second arrangements of microcontrollers, wherein the run lists contain the activation times for the transmitters and the receivers during one measuring cycle, and
transmitting trigger signals from the central control unit to the first and second arrangements of microcontrollers for activating specific transmitters or receivers, wherein the trigger signals contain references to the run lists stored therein.

20. The method of claim 19, further comprising computing in the microcontrollers the transmitter or receiver to be activated using the references in the trigger signal to the respective run list.

21. The method of claim 19, further comprising reading the run lists into the first and second arrangements of microcontrollers.
